(19) United States
(12) Patent Application Publication
(10) Pub. No.: US 2010/0139548 A1
(43) Pub. Date: Jun. 10, 2010

(54) CLUSTER STRUCTURE FOR VEHICLE

(75) Inventor: Ki Tae Eom, Gyeonggi-do (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR)

(21) Appl. No.: 12/534,179

(22) Filed: Aug. 3, 2009

(30) Foreign Application Priority Data
Dec. 5, 2008 (KR) 10-2008-0123638

(51) Int. Cl. B60Q 1/50

(52) U.S. Cl. 116/28 R

(57) ABSTRACT

A cluster structure for a vehicle includes a scale part including a display part for displaying various conditions of the vehicle, a light source part for emitting light to illuminate the scale part, and a light spreading part for guiding the light emitted from the light source part to spread onto the scale part. The scale part, the light spreading part, and the light source part are formed in a body to provide a unit cluster structure. With this, manufacturing costs can be reduced, assembly process can be simplified, and outer appearance can be improved.

### CROSS-REFERENCE TO RELATED APPLICATION

This application is based on and claims priority from Korean Patent Application No. 10-2008-0123638, filed on Dec. 5, 2008, the disclosure of which is incorporated herein in its entirety by reference.

### BACKGROUND

1. Technical Field

The present invention relates to a cluster structure for a vehicle, in which a scale part, a spread lighting part, and a light source part thereof are formed in a body.

2. Related Art

FIG. 1A is a perspective view illustrating an example of a conventional cluster structure, and FIG. 1B is a cross-sectional view of the example cluster structure.

As illustrated in FIGS. 1A and 1B, the cluster structure includes a scale part 1, a light spreading part 3, and a light source part 5. To achieve stereoscopic effect, the scale part 1, the light spreading part 3 and the light source part 5 each are provided as a separate structure. The separate structures, however, increase material costs and require additional assembly processes.

In addition, since the scale part 1 is finished by laser cutting after it is coated, it is difficult to impart impression of transparent acryl on the side surface of the scale part.

The above information disclosed in this Background section is only for enhancement of understanding of the background of the invention and therefore it may contain information that does not form the prior art that is already known in this country to a person of ordinary skill in the art.

### SUMMARY

One object of the present invention is to provide a cluster structure for a vehicle, which can be manufactured with a reduced number of materials and in a simplified assembly process.

Another object is to provide a cluster structure for a vehicle with improved external appearance.

According to an embodiment of the present invention, a cluster structure for a vehicle includes a scale part, a light spreading part, and a light source part formed in a body.

The unit cluster structure may be formed in a manner that the scale part is projected to be upwardly inclined at a specified angle, the spread lighting part is extended for a specified length from the scale part in a horizontal direction, and the light source part is bent downward from an end portion of the spread lighting part.

A mood lighting part and/or a separate corrosion and pattern may be further formed in a body with the unit cluster structure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other objects, features and advantages of the present invention will be more apparent from the following detailed description taken in conjunction with the accompanying drawings, in which:

FIG. 1A is a perspective view illustrating an example conventional cluster structure;

FIG. 1B is a cross-sectional view taken along line A-A in FIG. 1A;

FIGS. 2A and 2B are plan views of a cluster structure according to an embodiment of the present invention;

FIG. 2C is a cross-sectional view taken along line B-B in FIG. 2B; and

FIG. 2D is a perspective view of a cluster structure according to an embodiment of the present invention.

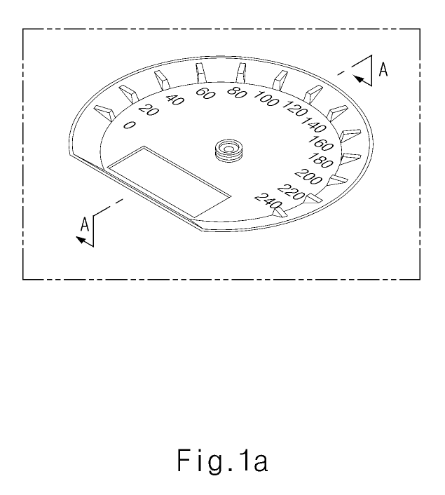

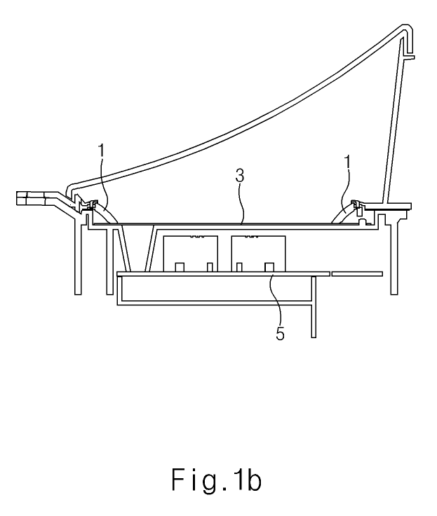

### DETAILED DESCRIPTION OF THE EMBODIMENTS

Hereinafter, a cluster structure for a vehicle according to an embodiment of the present invention will be described in detail with reference to the accompanying drawings.

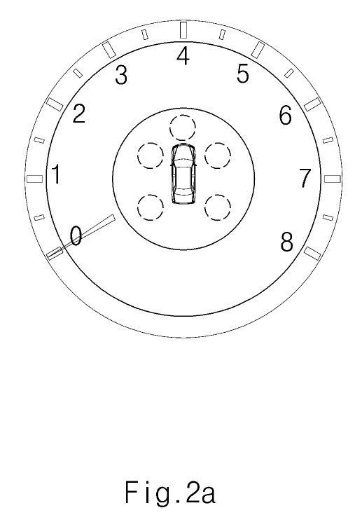

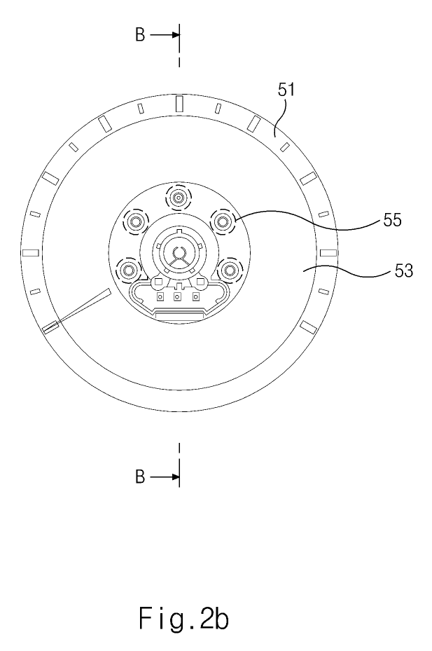

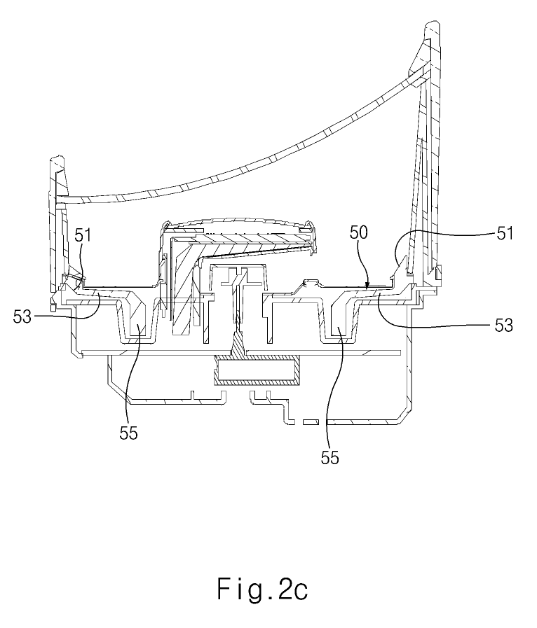

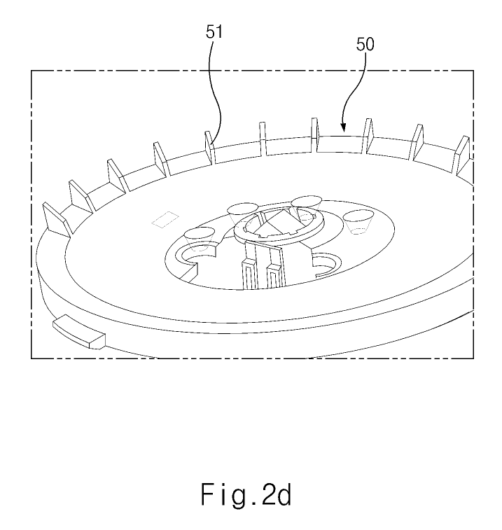

Referring to FIGS. 2B, 2C and 2D, the cluster structure according to an embodiment of the present invention includes a scale part 51, a light spreading part 53, a light source part 55 formed in a body.

The scale part 51 includes a display part for displaying various conditions of the vehicle, such as a speedometer, a fuel meter, and the like. The light source part 55 (e.g., LEDs) emits light for illuminating the scale part 51. The light spreading part 53 guides the light emitted from the light source part 55 to spread onto some or all of the scale part 51.

In the unit cluster structure, the scale part 51 is projected to be upwardly inclined at a specified angle. The light spreading part 53 is extended for a specified length from the scale part 51 in a horizontal direction. The light source part 55 is bent downward from an end portion of the light spreading part 53. And The light source part 55 is the part which receive the light emitting from the light source(un illustrated).

Since the unit cluster structure 50 can be manufactured by injection molding, the assembly processes can be shortened. The number of light sources becomes reduced, which can lower the manufacturing costs. Also, the unit structure obtained by the injection molding improves the external appearance.

In a modified embodiment, a mood lighting part (not illustrated) can be formed in a body with the unit cluster structure 50. With this, the mood lighting can be implemented cost-effectively, and the number of blue light sources can be reduced in comparison to the conventional cluster structure.

In another modified embodiment, a corrosion and pattern can be formed in a body with the unit cluster structure 50. In this case, additional separate print and structure for securing uniform illumination are not required.

As described above, according to the cluster structures according to the present invention, since the constitutional members included in the cluster are formed in a body by injection molding, the number of light sources such as LEDs can be reduced and additional injection-molded products are not required, thereby reducing the manufacturing costs.

In addition, since assembling separate structures is not involved, uniform product quality can be easily attained and various design of out appearance can be achieved.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A cluster structure for a vehicle comprising:
a scale part including a display part for displaying various conditions of the vehicle;
a light source part for emitting light to illuminate the scale part; and
a light spreading part for guiding the light emitted from the light source part to spread onto the scale part;
wherein the scale part, the light spreading part, and the light source part are formed in a body to provide a unit cluster structure.

2. The cluster structure of claim 1, wherein the unit cluster structure is formed in a manner that the scale part is projected to be upwardly inclined at a specified angle, the light spreading part is extended for a specified length from the scale part in a horizontal direction, and the light source part is bent downward from an end portion of the spread lighting part.

3. The cluster structure of claim 1, wherein a mood lighting part is added in a body with the unit cluster structure.

4. The cluster structure of claim 1, wherein a separate corrosion and pattern for securing uniform illumination is formed in a body with the unit cluster structure.
